(19) United States
(12) Patent Application Publication
(10) Pub. No.: US 2015/0149952 A1
(43) Pub. Date: May 28, 2015

(54) TEXT INPUT FOR ABUGIDA WRITING SYSTEMS WITH CONJUNCTS

(71) Applicant: QUALCOMM Incorporated, San Diego, CA (US)

(72) Inventors: Pawan Kumar BAHETI, Bangalore (IN); Abhijeet S. Bisain, San Diego, CA (US); Santanu Chaudhury, New Delhi (IN); Anirudh Seksaria, Mordi (IN)

(73) Assignee: QUALCOMM Incorporated, San Diego, CA (US)

(21) Appl. No.: 14/092,815

(22) Filed: Nov. 27, 2013

(51) Int. Cl. G06F 17/27; G06K 9/00; G06F 3/0488; G06F 3/0481; G06F 3/0486

(52) U.S. Cl. CPC G06F 17/276; G06F 3/04817; G06F 3/0486; G06F 3/04883; G06K 9/00416; G06K 9/00429
USPC 715/780; 382/189

(57) ABSTRACT

Disclosed embodiments pertain to a method on a Mobile Station (MS) for input of text for abugida writing systems. In some embodiments, the method may comprise obtaining a base character by performing Optical Character Recognition (OCR) on written user-input on the MS. A conjunct character may also be obtained by applying one or more functional or diacritical operators to the base character. The conjunct character may then be displayed.

### BACKGROUND

In abugida or alphasyllabary writing systems such as Devanagari, which is part of the large Brahmic family of scripts, consonant-vowel sequences may be written as a unit, where each unit is based on a base consonant letter, and vowel notations may be indicated by diacritical marks or modifiers. In addition, for example, in Devanagari, vowels may also be written in base independent form when occurring at the beginning of a word, or when following another vowel.

Further, in writing systems such as Devanagari and other Indic scripts, consonant clusters may be also be combined and written using conjuncts, which are more formally called typographic ligatures or ligatures. Ligatures are formed when a plurality of graphemes in a script are joined into a single symbol or glyph in the script. A grapheme or a base character may be viewed as the smallest semantically distinguishing unit in a script. As used herein, the term conjunct is used to refer to consonant-vowel combinations, consonant-consonant combinations, and consonant-consonant-vowel combinations. Consonant-consonant-vowel combinations are conjuncts which have been further modified by diacritical marks.

As a consequence of the possible combinations of graphemes with diacritical marks and conjuncts, the number of distinct units or characters in a script can grow rapidly. For example, in Devanagari, with approximately 12 vowels, 34 consonants and 16 diacritical marks, the consonant-consonant sequences yield over 1156 conjunct characters (or conjuncts). In addition, there are also a multitude of characters formed as a consequence of unique consonant-diacritical mark combinations that correspond to each consonant-vowel sequence.

The input of such a large number of characters on modern electronic devices, such as tablets, handheld devices, smartphones, etc. in an intuitive and efficient manner can be a challenge for users, device manufacturers and application developers.

For example, many implementations for the input of Indic text or other abugida writing systems with conjuncts may use three or more virtual keyboards, where a user alternates between keyboards for vowels, consonants, diacritical marks, and conjuncts. The use of several virtual keyboards makes texting, e-mail and various other applications impractical and unwieldy. Moreover, even with multiple virtual keyboards, in conventional schemes, conjuncts often require multi-key combinations.

Therefore, there is a need for a system to facilitate efficient and intuitive user text input for abugida writing systems with conjuncts such as Indic text.

### SUMMARY

In some embodiments, a processor-implemented method for input of text for abugida writing systems on a Mobile Station (MS) may comprise obtaining a base character, the base character being obtained by performing Optical Character Recognition (OCR) on written user-input on the MS; applying one or more functional operators to the base character to obtain a conjunct character, the functional operators comprising at least one of a diacritical operator or a conjunct operator; and displaying the conjunct character.

In another aspect, an MS may comprise: a memory to store a plurality of base characters in an abugida writing system, a touchscreen to receive written user input comprising text for the abugida writing system, and a processor coupled to the memory and the touchscreen. The processor may be configured to: obtain a base character from the plurality of stored base characters, the base character being obtained by performing Optical Character Recognition (OCR) on the written user-input, and apply one or more functional operators to the base character to obtain a conjunct character, the functional operators comprising at least one of a diacritical operator or a conjunct operator. In some embodiments, the MS may further comprise a display coupled to the processor, the display for displaying the conjunct character.

In a further aspect, an MS may comprise storage means to store a plurality of base characters in an abugida writing system, input means to receive written user input comprising text for the abugida writing systems, and processing means coupled to the storage means and the input means. In some embodiments, the processing means may comprise: means for obtaining a base character, the base character being obtained using Optical Character Recognition (OCR) means to perform OCR on the written user-input, and means for applying one or more functional operators to the base character to obtain a conjunct character, the functional operators comprising at least one of a diacritical operator or a conjunct operator. In some embodiments, the MS may further comprise display means coupled to the processing means, the display means to display the conjunct character.

In some embodiments, a computer-readable medium may comprise instructions, which when executed by a processor, may perform steps in method on a Mobile Station (MS) for input of text for abugida writing systems. The steps may comprise: obtaining a base character, the base character being obtained by performing Optical Character Recognition (OCR) on written user-input on the MS; applying one or more functional operators to the base character to obtain a conjunct character, the functional operators comprising at least one of a diacritical operator or a conjunct operator; and displaying the conjunct character.

Disclosed embodiments also pertain to apparatuses, systems, program code including firmware, and computer-readable media embodying instructions to perform the above methods.

### BRIEF DESCRIPTION OF THE DRAWINGS

FIG. 1 shows an exemplary Mobile Station (MS) that may be used for input of text in abugida writing systems with conjuncts in a manner consistent with embodiments disclosed herein.

FIG. 2 shows an exemplary GUI 200 for the input of text for abugida writing systems with conjuncts on an MS.

FIGS. 3A and 3B show an exemplary derivation of normalized feature vector sequences based on user input.

FIGS. 4A-4C show an exemplary GUI 200 for input of text and other exemplary operations for abugida writing systems with conjuncts in a manner consistent with disclosed embodiments.

FIG. 4D shows a set of exemplary recognized characters and potential candidate characters for correcting the recognized text.

FIG. 5 shows a flowchart of an exemplary method 300 for input of text in abugida writing systems with conjuncts in a manner consistent with disclosed embodiments.

FIG. 6 shows a flowchart of an exemplary method 375 for input of text in abugida writing systems with conjuncts in a manner consistent with disclosed embodiments.

FIG. 7 shows an exemplary process flow 400 illustrating the text input in abugida writing systems with conjuncts in a manner consistent with disclosed embodiments.

### DETAILED DESCRIPTION

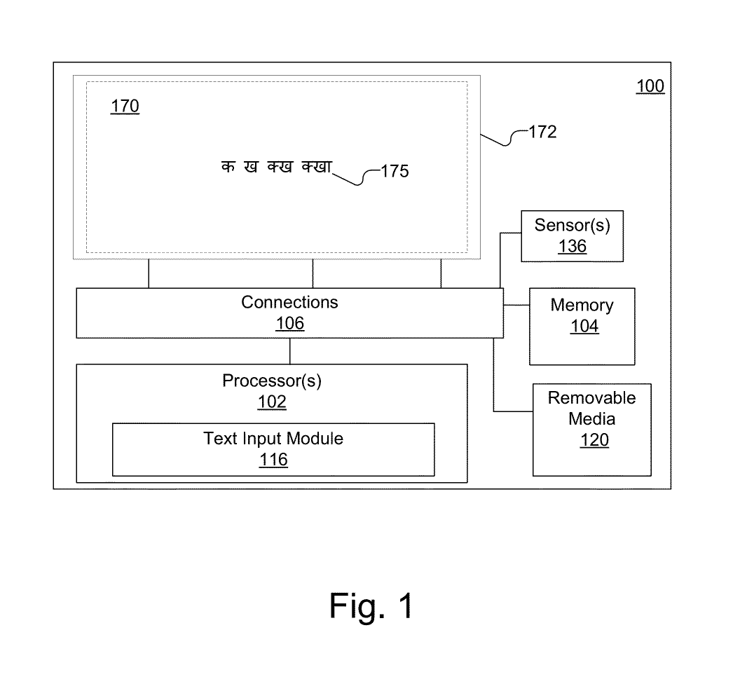

FIG. 1 shows schematic block diagram illustrating certain exemplary features of an exemplary mobile station or mobile device that may be used for input of text in abugida writing systems with conjuncts in a manner consistent with embodiments disclosed herein.

Mobile Station (MS) 100 may, for example, include: one or more processors 102, memory 104, removable media drive 120, display 170, touchscreen 172, and, as applicable, various sensors 136, which may be operatively coupled using one or more connections 106 (e.g., buses, lines, fibers, links, etc.). As used herein, mobile device or mobile station (MS) 100, may take the form of a cellular phone, mobile phone, or other wireless communication device, a personal communication system (PCS) device, personal navigation device (PND), Personal Information Manager (PIM), or a Personal Digital Assistant (PDA), a laptop, tablet, notebook and/or handheld computer. The terms mobile device or mobile station are used interchangeably herein. In some embodiments, MS 100 may be capable of receiving wireless communication and/or navigation signals.

Further, the term “mobile station” is also intended to include devices which communicate with a personal navigation device (PND), such as by short-range wireless, infrared, wireline connection, or other connections and/or position-related processing occurs at the device or at the PND. Also, “mobile station” is intended to include all devices, including various wireless communication devices, which are capable of communication with a server, regardless of whether wireless signal reception, assistance data reception, and/or related processing occurs at the device, at a server, or at another device associated with the network. Any operable combination of the above are also considered a “mobile station.” In some embodiments, MS 100 may also include one or more ports for communicating over wired networks.

In some embodiments, display 170 (shown in FIG. 1 by the dashed block) may permit the display of visual output. Touchscreen 172 may permit users to input data via some combination of virtual keyboards, icons, menus, or other Graphical User Interfaces (GUIs), user gestures and/or input devices such as styli and other writing implements. In some embodiments, touchscreen 172 may overlay display 170, which may concurrently display input entered by a user or provide other visual feedback based on the input. In some embodiments, touchscreen 172 may be implemented, for example, using a pressure sensitive screen such as a capacitive or resistive touchscreen. In some embodiments, display 170 may be implemented using a Liquid Crystal Display (LCD) display or a Light Emitting Diode (LED) display, such as an Organic LED (OLED) display. In other embodiments, display 170 may be a wearable display, which may be operationally coupled to, but housed separately from, other functional units in MS 100. In some embodiments, touchscreen 172 may form part of a user input functional unit or module, which may include a combination of hardware and software components to receive input.

Further, exemplary MS 100 may be modified in various ways in a manner consistent with the disclosure, such as, by combining (or omitting) one or more of the functional blocks shown. For example, in some embodiments, MS 100 may comprise one or more of speakers, microphones, transceivers (e.g., wireless network interfaces), Satellite Positioning System (SPS) receivers and one or more Cameras 130. Further, in certain example implementations, portions of MS 100 may take the form of one or more chipsets, and/or the like.

Processors 102 may be implemented using a combination of hardware, firmware, and software. In some embodiments, processing unit 102 may include Text Input Module 116, which may facilitate the processing of input in abugida writing systems with conjuncts. For example, Text Input Module 116 may facilitate the input of Indic scripts, such as the Brahmic family of scripts, which includes the Devanagari script.

In one embodiment, Text Input Module 116 may process user input received using touchscreen 172, which may capture the coordinates of the points of contact, time(s) or time period(s) associated with each point contact, the sequence in which the points of contact occurred, and/or other parameters associated with each point of contact. The points of contact and parameters associated with each point of contact and/or a set of points of contact may be relayed to Text Input Module 116, which may use the points of contact and parameters to interpret user gestures, recognize strokes of a script, perform Optical Character Recognition, and/or identify other context-dependent input. In some embodiments, input which has been captured by touchscreen 172 and processed by Text Input Module 116 may be displayed as Indic Text 175 using Display 170. In one embodiment, Text Input Module 116 may use a combination of parameters such as user indication, the current location of the stylus, the displacement between two consecutive contact points, the use of a space bar, or the duration of a pause between strokes, context-sensitive techniques, etc to determine when the entry of a character has been completed.

Processors 102 may also be capable of processing other information either directly or in conjunction with one or more other functional blocks shown in FIG. 1. For example, processors 102 may process and combine raw measurements from sensors 136. Sensors 136 may include touch sensors including multi-touch sensors, acoustic sensors such as microphones and speakers, ambient light sensors, and various others, which, in some instances, may be coupled to display 170 and/or touchscreen 172. For example, in one embodiment, input from the ambient light sensor may be used to adjust the brightness of display 170. In some embodiments, processors 102 may represent one or more circuits configurable to perform at least a portion of a computing procedure or process related to Text Input Module 116 in a manner consistent with disclosed embodiments.

The methodologies described herein may be implemented by various means depending upon the application. For example, these methodologies may be implemented in hardware, firmware, software, or any combination thereof. For a hardware implementation, processors 102 may be implemented within one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic units designed to perform the functions described herein, or a combination thereof.

For a firmware and/or software implementation, the methodologies may be implemented using procedures, functions, and so on that perform the functions described herein. Any non-transitory machine-readable medium tangibly embodying instructions may be used in implementing the methodologies described herein. Non-transitory computer-readable media may include physical computer storage media. A storage medium may be any available medium that can be accessed by a computer. In one embodiment, software code pertaining to the processing of text input for abugida writing systems with conjuncts may be stored in a non-transitory computer-readable medium and read using removable media drive 120 and executed by at least one of processors 102. For example, the methods and/or apparatuses presented herein may take the form in whole or part of a computer-readable medium that may include program code to support Text Input Module 116 in a manner consistent with disclosed embodiments.

Non-transitory computer-readable media may include a variety of physical computer storage media. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Memory 104 may be implemented within processors 102 and/or external to Processor 102. As used herein the term “memory” refers to any type of long term, short term, volatile, nonvolatile, or other memory and is not to be limited to any particular type of memory or number of memories, or type of media upon which memory is stored. In general, memory 104 may represent any data storage mechanism. Memory 104 may include, for example, a primary memory and/or a secondary memory. Primary memory may include, for example, a random access memory, read only memory, etc. While illustrated in FIG. 1 as being separate from processors 102, it should be understood that all or part of a primary memory may be provided within or otherwise co-located/coupled with processors 102. Memory 104 may hold instructions and data for processors 102 and/or Text Input Module 116. For example, memory 104 may hold program code for Text Input Module 116, databases, lookup tables, font tables, etc.

Secondary memory may include, for example, the same or similar type of memory as primary memory and/or one or more data storage devices or systems, such as, for example, flash/USB memory drives, memory card drives, disk drives, optical disc drives, tape drives, solid state memory drives, etc. In certain implementations, secondary memory may be operatively receptive of, or otherwise configurable to couple to a non-transitory computer-readable medium in removable drive 120. In some embodiments, non-transitory computer readable medium may form part of memory 104.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions.

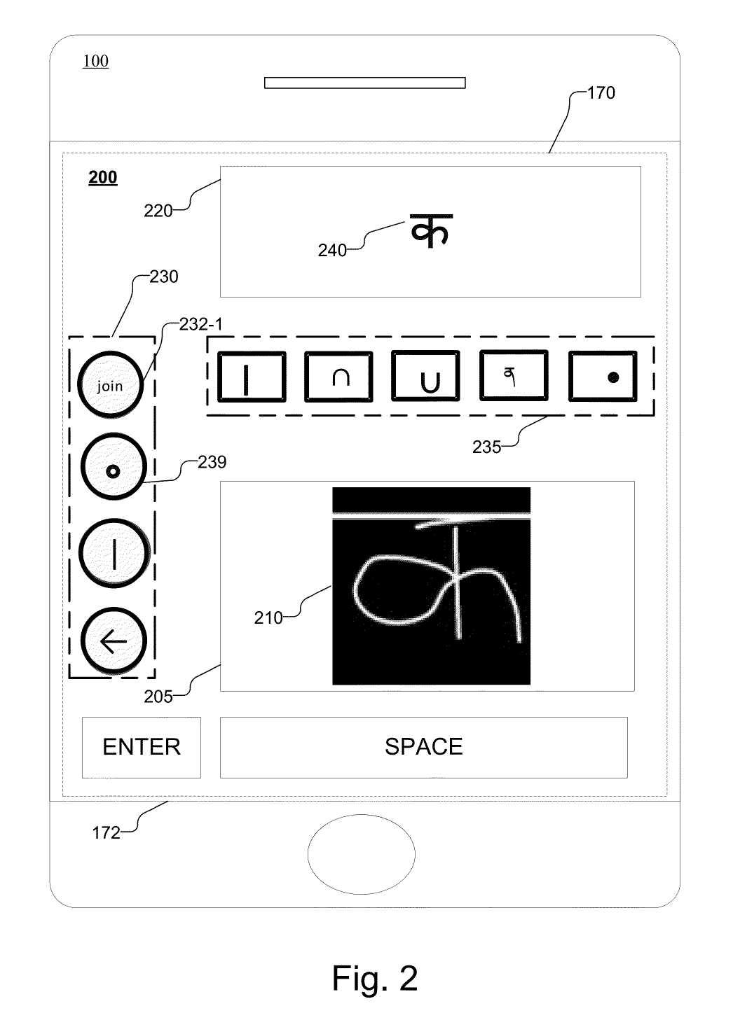

FIG. 2 shows an exemplary GUI 200 for the input of text for abugida writing systems with conjuncts on MS 100 with display 170 and touchscreen 172. In FIGS. 2, 3A-3B, and 4A-4D, to simplify the description, many functional elements of MS 100 have not been shown. Further, in some figures, one or more elements may have been omitted for clarity and some elements shown may not be to scale and others may have been exaggerated to show detail. Elements labeled with the same identifier perform similar functions in the figures.

As shown in FIG. 2, a user may enter Indic text 210 shown as the consonant character “ [symbol] ” for an application such as a texting application in window 205. In some embodiments, the Indic text may be entered by user writing on the touchscreen 210 within window 205 with a stylus or another writing implement. In one embodiment, input character “ [symbol] ” 210 may be displayed to the user in window 205 during input.

In some embodiments, when text is written on touchscreen 172, information pertaining to a temporal sequence of stylus contact points on touchscreen 172 may be captured. For example, the information captured may comprise the (X, Y) coordinates of an ordered set of contact points C={C₁, C₂ . . . Cₙ} relative to a touchscreen coordinate system or frame of reference during some time period and the points C₁-Cₙ may be ordered in sequence based on a time of contact associated with the respective contact point. As an example, contact point C₁ may occur prior to contact point C₂.

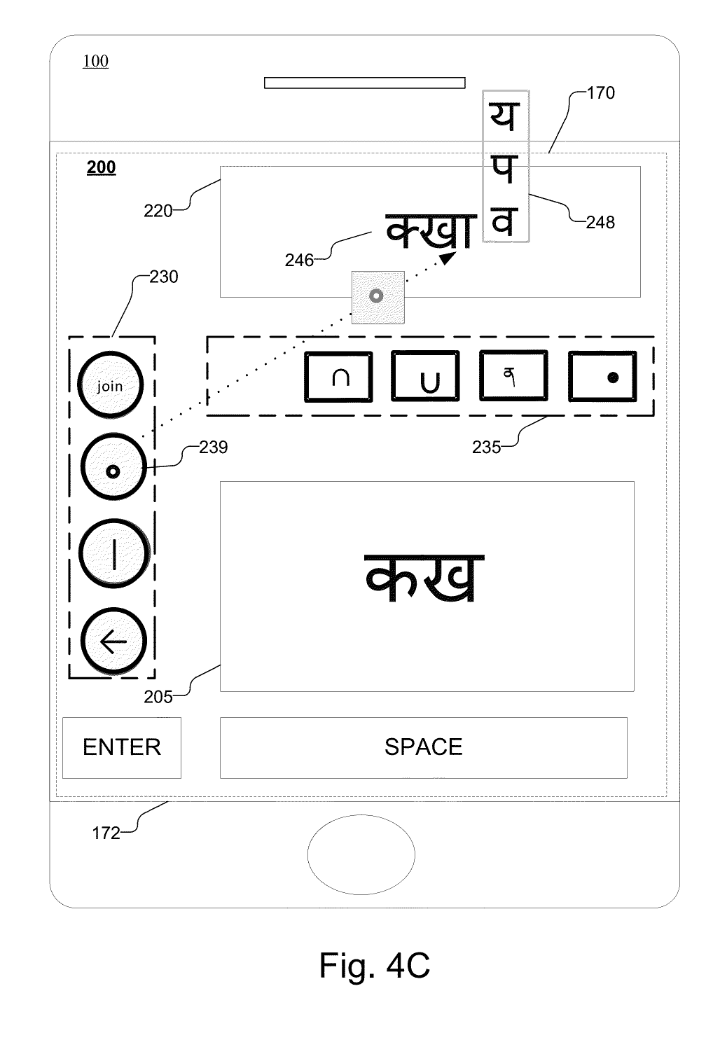

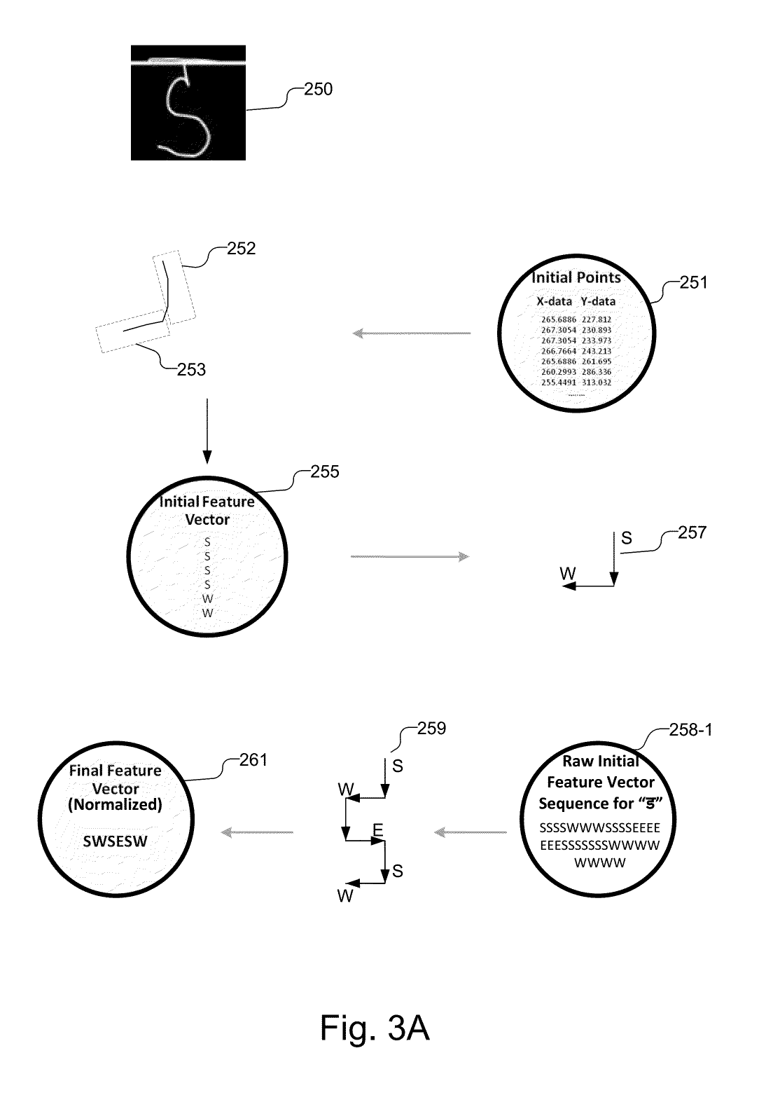

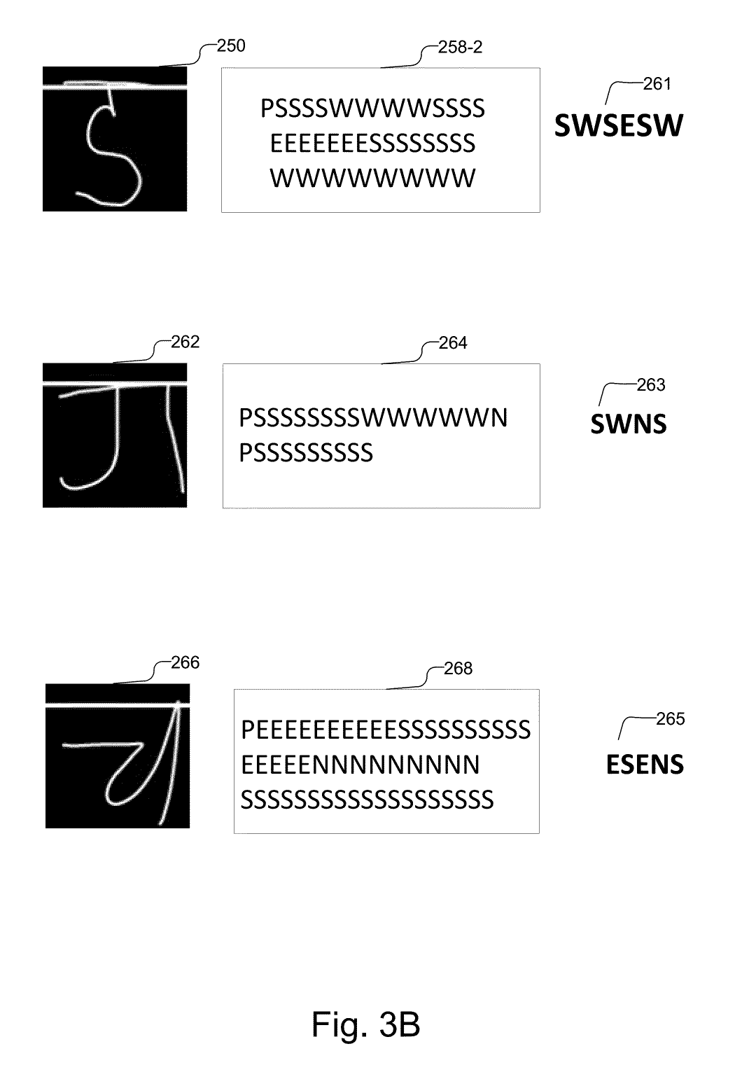

FIG. 3A illustrates the derivation of a vector sequence for an exemplary character “ [symbol] ” 250. As shown in FIG. 3A, exemplary character “ [symbol] ” 250 may be input by a user. Upon input, a sequence of (x, y) coordinates of contact points 251 may be obtained related to the character “ [symbol] ” 250 entered by the user. An initial sequence (x, y) coordinates of contact points 251 for the character “ [symbol] ” 250 is shown in Table 1 below.

TABLE 1
Initial (x, y) coordinates of Contact Points

| X coordinate of | Y coordinate of |
|---|---|
| contact point | contact point |
| 265.6886 | 227.812 |
| 267.3054 | 230.893 |
| 267.3054 | 233.973 |
| 266.7664 | 243.213 |
| 265.6886 | 261.695 |
| 260.2993 | 286.336 |
| 255.4491 | 313.032 |
| . . . | . . . |

As can be seen from Table 1 above, there is relatively little variation in the X coordinate of the contact points initially, while the Y-coordinates vary. Thus, the initial sequence of contact points 251 for the character “ [symbol] ” 250 corresponds to the set of substantially vertically oriented line segments (shown within the dashed box) 252 in FIG. 3A. For the discussion here, the horizontal bar/line (also called a “shiro-rekha”) at the top of the character is ignored. Similarly, the next set of contact points may correspond to the set of substantially horizontally oriented line segments (shown within the dashed box) 253 in FIG. 3A.

In one embodiment, a first feature vector V_{i-1, i} may be constructed by connecting the first contact point in the sequence of contact points to the next, for example consecutive contact points Cᵢ₋₁=(xᵢ₋₁, yᵢ₋₁) and Cᵢ=(xᵢ, yᵢ) may be connected. In one embodiment, the angular displacement of feature vector V_{i-1, i} between two contact points can be determined relative to an axis in a frame of reference associated with touchscreen 170. Based on the value of the angular displacement of feature vector V_{i-1, i} relative to the designated axis, the feature vector may be labeled with one of a plurality of identifiers or labels. In some embodiments, the process above may be repeated by connecting the next two contact points Cᵢ=(xᵢ, yᵢ) and Cᵢ₊₁=(xᵢ₊₁, yᵢ₊₁) to obtain vector V_{i, i+1} and a label for vector V_{i, i+1} based on its angular displacement relative to the designated axis. In some embodiments, each character in a script may be uniquely characterized by a sequence of feature vectors.

As an illustrative example, four feature vector labels may used to describe characters with labels given by N, S, E, and W. For example, the label “N” may be used to describe vectors that are oriented (along a Y-axis) toward the top of the page, “S” to describe vectors that are oriented (along the Y-axis) toward the bottom of the page, “E” to describe vectors that are oriented (along the X-axis) to the right of the page, and “W” to describe vectors that are oriented (along the X-axis) toward the left of the page. Thus, for character “ [symbol] ” 250, the initial feature vector sequence (or sequence of labels) based on consecutive contact points represented by the sets of line segments 252 and 253 may take the form SSSSWW 255, which may be normalized to the initial vector sequence shown graphically as SW 257 by using a single label to represent a sequence of consecutive repeated labels. For example, in initial feature vector sequence 255, the sequence “SSSS” may be normalized to “S” and the sequence “WW” may be normalized to “W” to yield vector sequence “SW”.

In general, normalization may be performed on a raw vector sequence by replacing a sequence of consecutive repeated labels (such as “EEEE”) with a single instance of the repeated label (e.g. “E”), or equivalently, by retaining the first label in a sequence of consecutive repeated labels (e.g. “E”) in a raw feature vector sequence (e.g. “EEEE”) and eliminating subsequent consecutive duplicated labels (e.g. “EEE”) in the sequence.

A raw or initially captured feature vector sequence 258-1 for the entire character “ [symbol] ” 250 is also shown in FIG. 3A, which may be based, for example, on the values of angular displacements of segments between consecutive contact points relative to the X-axis. The raw or initial vector sequence that characterizes exemplary character “ [symbol] ” 250 may be normalized to feature vector sequence SWSESW 261, which is also shown using a graphical representation 259 in terms of the feature vectors N, S, E and W. As shown in FIG. 3A, the normalized feature vector sequence for character “ [symbol] ” 250 may take the form SWSESW 261 after normalization.

The example above with four feature vectors is for illustrative purposes only, and, in general, the number of feature vectors used to characterize each symbol in a script may be based on the degree of sensitivity required, the speed of the processor, the resolution of the touchscreen, complexity of the script, and various other system parameters. In some embodiments, input from sensors 136 on MS 100 may be used to determine an orientation of MS 100 and appropriate adjustments may be made when calculating angular displacements or determining labels.

In some embodiments, each character in a script may be associated with a unique feature vector sequence. In some embodiments, the feature vector sequence corresponding to some subset of characters in the script and/or one or more other scripts may be stored in databases, Look-Up Tables (LUTs), font tables and/or character tables, linked lists, or other suitable data structures in memory 104 or MS 100. Therefore, by comparing the normalized feature vector sequence of the written use-input with the feature vector sequences stored in memory 104, characters 210 input by the user may be recognized.

FIG. 3B shows exemplary normalized feature vector sequences 261, 263 and 265 associated with characters “ [symbol] ” 250, “ [symbol] ” 262 and “ [symbol] ” 266, respectively. As shown in FIG. 3B, normalized feature vector sequences 261, 263 and 265 may be derived from initial or raw vector sequences 258-2, 264, and 268 obtained from contact points associated with the respective written user-input characters.

Referring to FIG. 2, in some embodiments, input character “ [symbol] ” 210 may be processed using an OCR application for Indic text and recognized character “ [symbol] ” 240 may be displayed to the user in window 220. In some embodiments, an OCR algorithm may use the feature vector sequence associated with the entered text to recognize the entered text by comparing the normalized feature vector sequence associated with the written user-input with feature vector sequences of characters stored in memory 104. Once a character with the same or a substantially similar feature sequence has been identified, then the character associated with that feature vector sequence, for example, character “ [symbol] ” 240, may be displayed.

OCR is typically a computationally intensive process and the computational cost may be higher for abugida languages with large numbers of conjuncts or ligatures. Therefore, in some embodiments, an OCR process may be configured to recognize graphemes, or base characters, which may then be configured to yield symbols in the script in a manner consistent with disclosed embodiments. As noted above, graphemes represent the smallest semantically distinguishing unit in a script.

As shown in FIG. 2, in some embodiments, GUI 200 may include a set of functional operator icons 230 and 235, which may be buttons invoked by tapping and/or drag and drop icons. For example, functional operator icons for diacritical marks 235 may correspond to the vowel portion of a consonant-vowel or consonant-consonant-vowel sequence. As noted earlier, in Indic scripts, a consonant-vowel or consonant-consonant-vowel sequence may be written as a unit based on the consonant or conjunct character with the vowel notations indicated by diacritical marks.

Further, in some embodiments, GUI 200 may also include other functional operator icons 230, such as conjunct operator 232-1, correction operator 239 etc. In some embodiments, conjunct operator 232-1 may be used to generate consonant-consonant conjuncts or ligatures. Note that the locations of the set of diacritical mark icons 235 and functional operator icons 230 in GUI 200 may be changed. For example, the locations of the icons may be user-configurable. In one embodiment, the icons may be transparent or semi-transparent and may be placed within and/or close to the edges of window 205 to facilitate quick user-access. In some embodiments, a conjunct character may be further modified by adding diacritical marks using one of diacritical operators 235.

Further, in some embodiments, GUI 200 may comprise a simple user-configurable single keyboard layout, which may include graphemes and independent vowels, along with functional operators 230 and 235 to permit text entry in a manner consistent with disclosed embodiments.

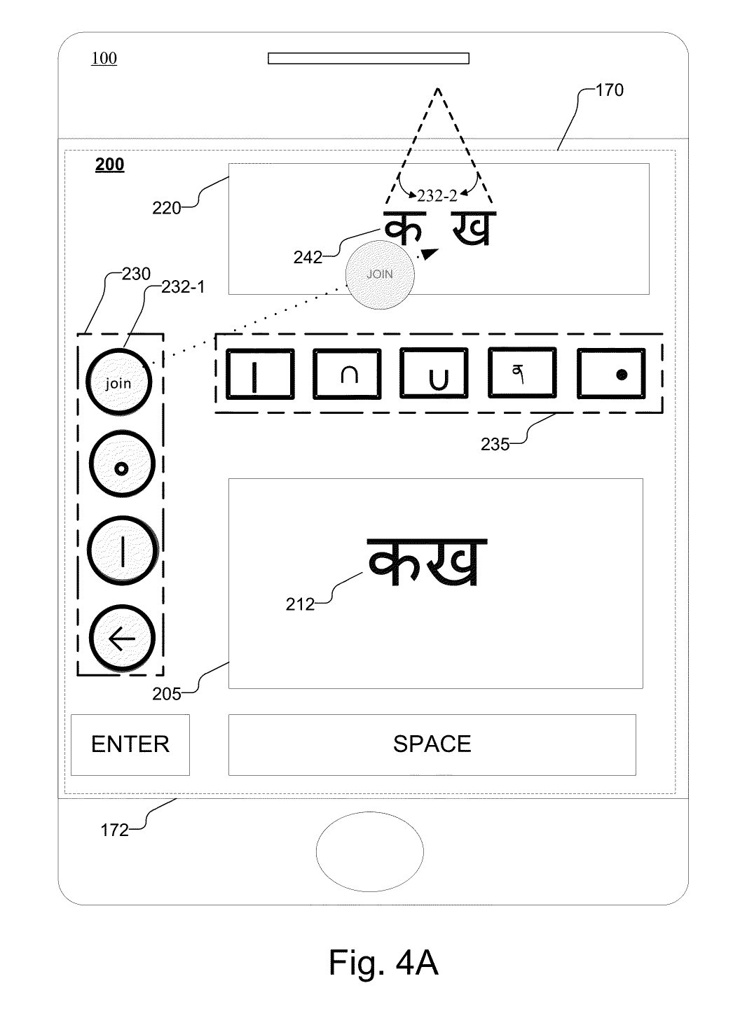

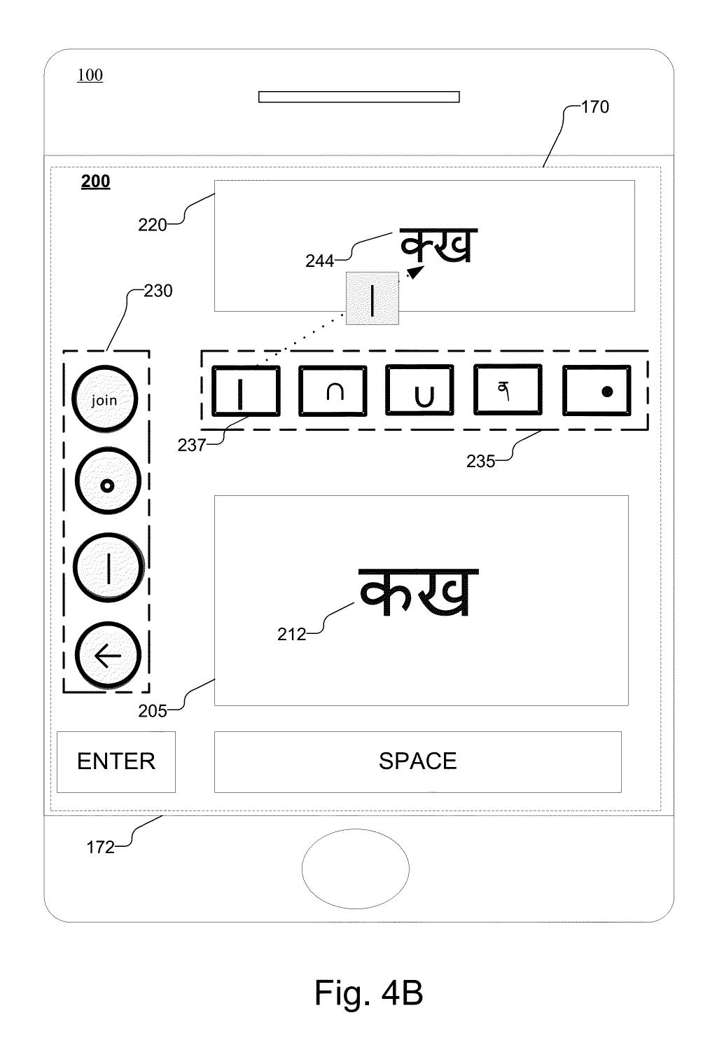

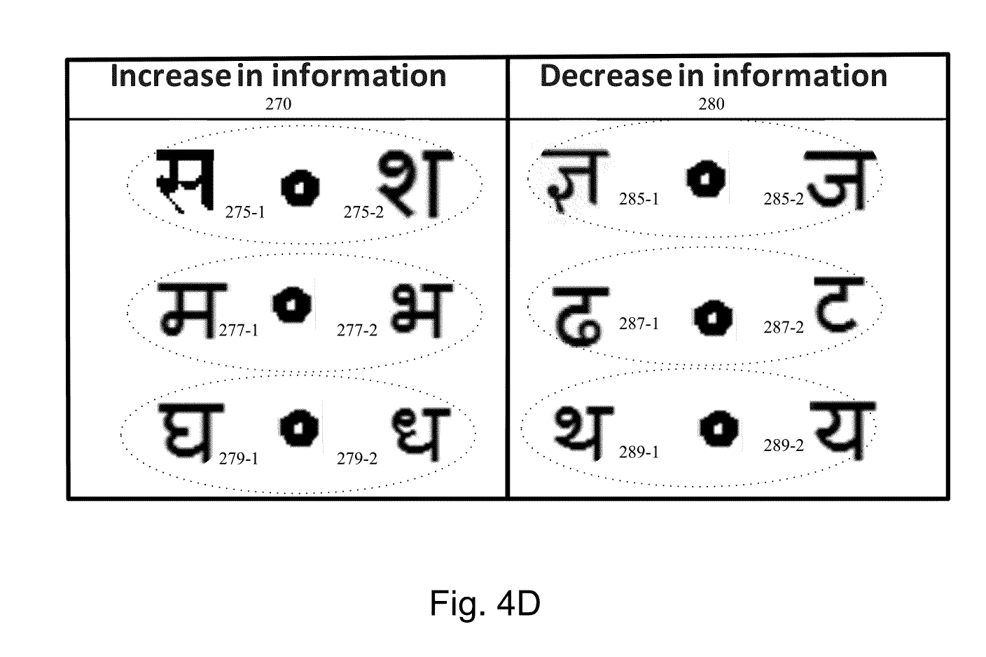

FIG. 4A shows the use of “Join” functional operator 232 in exemplary GUI 200 to create conjuncts. In FIG. 4A, window 205 holds the character string 212 “ [symbol] [symbol] ” indicating the entry of new character “ [symbol] ”. In FIGS. 4A-4C, for simplicity, the actual user-strokes entered in window 205 have not been shown. As shown in FIG. 4A, after OCR, newly entered character “ [symbol] ” appears in window 220.

In one embodiment, when Join operator 232-1 is dragged and dropped into window 220, for example, at a location between characters “ [symbol] ” and “ [symbol] ”, then, as shown in FIG. 4B, conjunct character 244 “ [symbol] ” may be generated and displayed in window 220. In some embodiments, the Join operator may also be invoked, for example, as shown in FIG. 4A, by Join operation 232-2, using a “pinch” operation, where the user places a finger over the “ [symbol] ” and another over character “ [symbol] ” and then moves the fingers toward each other. Thus, the pinch operation may also be used to generate conjunct character 244 “ [symbol] ” shown in window 220 in FIG. 4B. In some embodiments, a conjunct of the two most recently entered characters, such as the currently entered character and an immediately preceding character, may be generated whenever the user taps or otherwise invokes join operator 232-1, while the drag and drop or pinch invocations of join operator 232-2 may be used to form conjuncts of specific previously entered characters.

Further, as shown in FIG. 4B, when diacritical mark or modifier primitive 237 “|” is dragged and dropped into window 220, for example, at a location near character “ [symbol] ”, then, as shown in FIG. 4C, conjunct character 246, “ [symbol] ” (a consonant-consonant-vowel combination) may be generated and displayed in window 220. In some embodiments, a conjunct of the current (or most recently entered) character and an immediately preceding character may be generated whenever the user taps on an icon or otherwise invokes conjunct operator 232, while the drag and drop invocation of diacritical marks may be used to form consonant-vowel conjuncts of the current or most recently entered character.

FIG. 4C also shows correction functional operator 239, which may be used to correct incorrectly recognized and or entered text. In one embodiment, when correction operator 239 is dragged and dropped into window 220, for example, at a location near character “ [symbol] ”, then, as shown in FIG. 4C, a set of other potential characters for correction 248 may be displayed. In one embodiment, the set of potential characters for correction 248 displayed may be based on their similarity or proximity to the recognized/entered character. In some embodiments, the set of potential characters for correction 248 displayed may be determined based on the nearest matching neighbors, on a historical frequency with which an entered/recognized character has been confused with another, or by using context and/or dictionaries to predict the word being entered.

In some embodiments, the set of potential characters for correction 248 may be populated with characters whose feature vector sequences are within some Levenshtein distance of the normalized feature vector sequence associated with the entered/recognized character. The “Levenshtein distance” or “edit distance” measures the difference between two string sequences. The Levenshtein distance between two words can be viewed as the minimum number of single-character edits (such as insertions, deletions, or substitutions) to change one word into the other. In some embodiments, the Levenshtein distance between the feature vector sequences or feature vector strings for two characters may be used as a measure of similarity between the two characters. For example, a set of potential correction characters may be determined based on the Levenshtein distance between the feature vector sequence of each character in the set of potential correction characters and the normalized feature vector sequence that is associated with an entered character.

In some embodiments, a database or table or LUT in memory that holds the feature vector sequence for a character may also hold characters that are within some Levenshtein distance of the feature vector for that character. For example, in one embodiment, a database or LUT may be indexed by a “feature vector sequence” or a “feature vector sequence key”, and a record in the database may hold the character to be displayed, the feature vector sequence for the character, as well as characters that are within various Levenshtein distances of that character. Accordingly, in some embodiments, the set of potential characters for correction 248 displayed may be efficiently determined during the OCR process for the entered character.

FIG. 4D shows a set of exemplary recognized characters 275-1, 277-1, 279-1, 285-1, 287-1 and 289-1 and potential candidate characters 275-2, 277-2, 279-2, 285-2, 287-2 and 289-2 for correcting the recognized text. In some embodiments, potential characters for correction may be selected based on characters whose feature vector sequences strings are within some Levenshtein distance of the feature vector sequence associated with the entered/recognized character.

Table 270 shows a set of recognized characters 275-1, 277-1 and 279-1 along with corresponding potential correction characters (shown by dashed ovals) 275-2, 277-2 and 279-2, respectively. In some embodiments, potential correction characters 275-2, 277-2 and 279-2 may be selected based on a Levenshtein distance of their respective feature vector sequences to the feature vector sequence associated with the corresponding recognized character and by adding information (e.g. adding one or more labels) to the feature vector sequence for the corresponding recognized character.

Table 280 shows a set of recognized characters 285-1, 287-1 and 289-1 along with potential correction characters 285-2, 287-2 and 289-2, respectively. In some embodiments, potential correction characters 285-2, 287-2 and 289-2 may be selected based on Levenshtein distance of their respective feature vector sequences to the feature vector sequence associated with the corresponding recognized character and by removing information (e.g. removing one or more labels) from the feature vector sequence for the corresponding recognized character.

In general, in some embodiments, potential correction characters may be determined by adding, removing and/or substituting labels from the feature vector sequence associated with a recognized character. Each addition, deletion or substitution operation may be given a weight and a Levenshtein distance may be computed between two feature vector sequences by adding the weights.

In FIG. 3B, for example, the feature vector sequence “SWSESW” 261 may be transformed to the feature vector sequence “SWNS” 263 by (i) deleting the third label “S” [SWSESW→SWESW] from feature vector sequence 261 (ii) deleting the last label “W” [SWESW→SWES] feature vector sequence 261 and (iii) substituting the label “N” for the fourth label “E” [SWES→SWNS] in feature vector sequence 261. Therefore, the Levenshtein distance between the feature vector sequence for the character “ [symbol] ” 250 and character “ [symbol] ” 262 in FIG. 3B is 3.

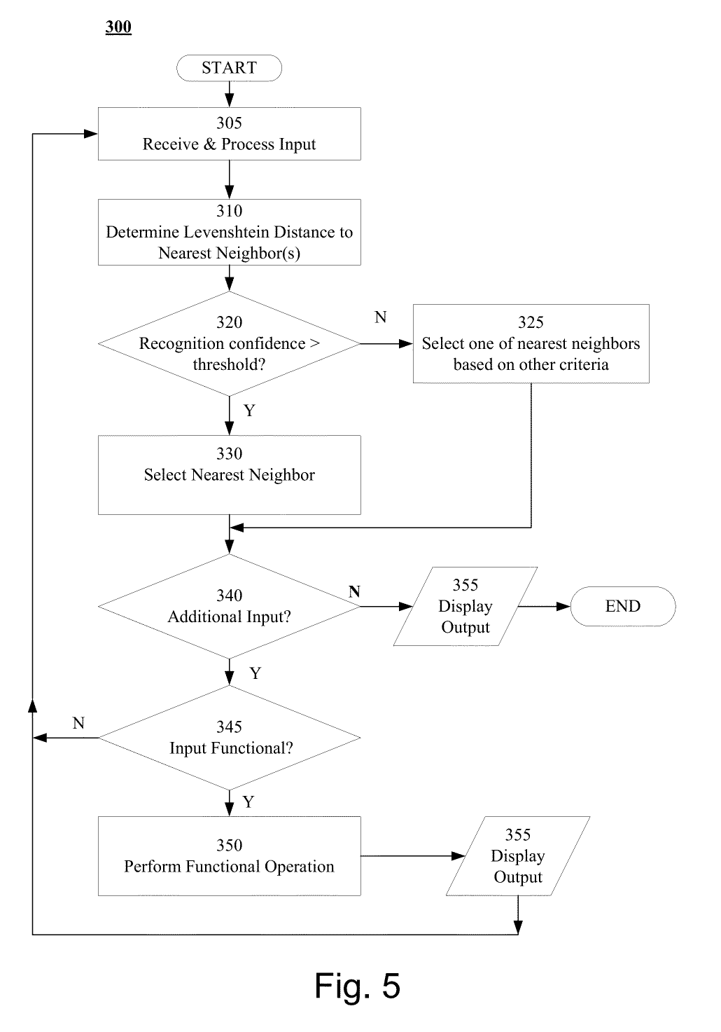

FIG. 5 shows a flowchart of an exemplary method 300 for input of text in abugida writing systems with conjuncts in a manner consistent with disclosed embodiments. For example, method 300 may be used for the input of Indic text. In some embodiments, portions of method 300 may be performed on MS 100 using Text Input Module 116. The following description of method 300 includes references to Indic text by way of example only. However, the methods disclosed may be applied to any abugida writing system with conjuncts in a manner consistent with disclosed embodiments as would be apparent to one of ordinary skill in the art.

In step 305, text input, such as Indic text input, may be received and processed. For example, if Indic text input is input in written form, then, in some embodiments, the written input may be processed to obtain a normalized feature vector sequence for the input character. In one embodiment, the graphemes or base characters may be entered using a simple keyboard, such as a virtual keyboard, or blue tooth keyboard. For example, graphemes may be entered using keys for some subset of base characters in the script such as independent vowels or single consonants.

In step 310, if the entered character was written, then, the obtained normalized feature vector sequence of the entered character may be matched with stored feature vector sequences of characters stored in memory 104. For example, the normalized feature vector sequence corresponding to the entered character may be compared with the feature vector sequences of one or more characters stored in a database or lookup table. In some embodiments, the Levenshtein distance between the normalized feature vector sequence corresponding to the entered character and the feature vector sequence corresponding to a stored character may be obtained. The stored characters, which are potential matches to the entered character, may be sorted in ascending order of Levenshtein distance. A zero Levenshtein distance represents an exact match. In general, a shorter Levenshtein distance between an entered character and a stored character may be indicative of more similarity between the two characters and point to a greater likelihood of a match. In embodiments, or instances, where the base character was entered using a virtual keyboard, step 340 may be directly invoked after step 305 for the current iteration bypassing steps 320, 325 and 330.

In step 320, if there is a match or a high confidence that one of the characters is a match (“Y”, in step 320), then, in step 330, the character that is the best match (lowest Levenshtein distance) may be selected as corresponding to the entered character. For example, in one embodiment, if only one character is within some predetermined threshold Levenshtein distance, then, that character may be selected as corresponding to the entered character.

In step 320, if there is no exact match or the confidence that a match has been obtained is below some threshold (“N”, in step 320), then, in step 325, one of the characters in a set of likely matches may be selected. For example, in one embodiment, the feature vector sequences of several characters may be within some Levenshtein distance of the entered character. Accordingly, in step 325, other criteria such as context and/or dictionaries, may be used to select a character from the set of likely matches. For example, one of the characters within the Levenshtein distance may be selected based on the frequency with which the current and an immediately preceding character occur together, previously entered/recognized characters, spellings of words that may be formed using prior characters, etc.

In step 340, if there is additional input (“Y” in step 340) then, in step 345, the method may determine if the input is functional. For example, if the input is functional (“Y” in step 345) and pertains to a diacritical function or a conjunct (join) function, then in step 350, the function may be applied. For example, in one instance, if a “join” or conjunct function invocation is registered then the previous two characters may be combined to form a conjunct. In another instance, if the conjunct function invocation is through a drag and drop operation, then the coordinates of the drop may be used to determine the characters to be combined and a conjunct character may be obtained by combining the characters in step 350. In some embodiments, the conjunct character to be displayed may be obtained by using the two consonant characters in sequence as an index to search a lookup table for a corresponding entry, which may comprise the conjunct character to be displayed.

In a further instance, if the input (“Y” in step 345) pertains to a diacritical function, then the appropriate diacritical mark may be added, in step 350, to the prior character. If the diacritical mark invocation is through a drag and drop operation, then the coordinates of the drop may be used to determine the character, which may then be modified with the diacritical mark in step 350.

In another instance, if the input (“Y” in step 345) pertains to a correction function, then a list of potential characters for correcting the prior input, such as list 248, may be displayed. In some instances, the list of potential characters for correcting the prior input may be based on the Levenshtein distance of the vector sequence to the entered character or the recognized character.

If the input in step 345, is non-functional and non-diacritical (“N” in step 345) then, the process returns to step 305 to begin another iteration.

In step 355, the recognized and/or selected character corresponding to the entered character after modification in step 350 may be displayed and the process returns to step 340 to begin the next iteration.

In step 340, if there is no additional input (“N” in step 340) then, in step 355, the character selected in steps 325 or 330 as corresponding to the entered character may be displayed and the process ends.

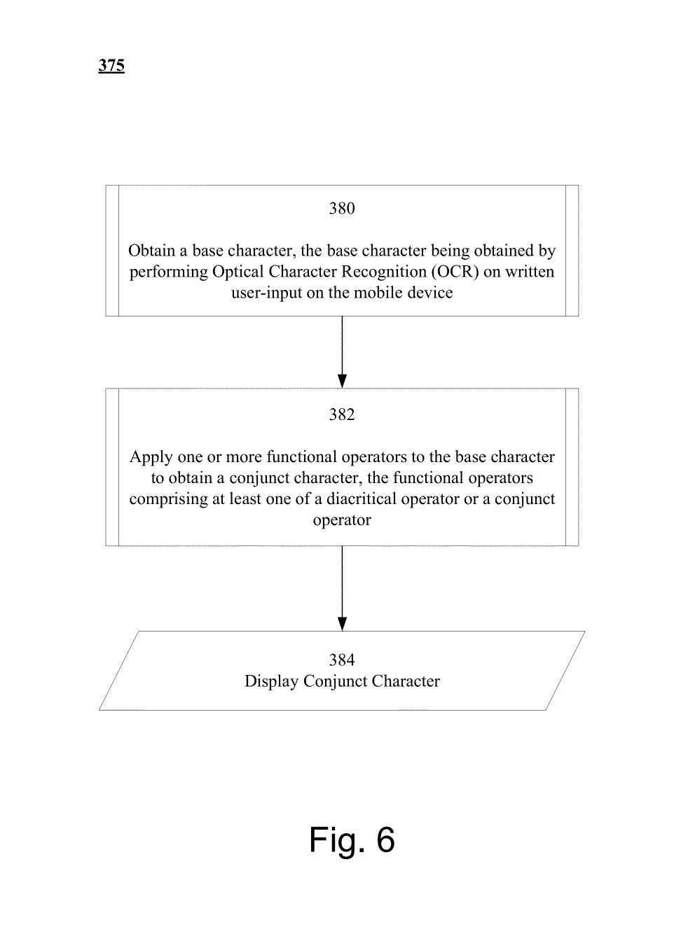

FIG. 6 shows a flowchart of an exemplary method 375 for input of text in abugida writing systems with conjuncts in a manner consistent with disclosed embodiments. In some embodiments, portions of method 375 may be performed by MS 100 using Text Input Module 116.

In step 380, a base character in the abugida writing system may be obtained by performing Optical Character Recognition (OCR) on written user-input, which may occur, for example, on MS 100. In some embodiments, OCR may be performed by obtaining a normalized feature vector sequence corresponding to the written user-input, where the normalized feature vector sequence is based on a set of contact points associated with the written user input. Further, the base character may be identified based, at least in part, on a comparison of the normalized feature vector sequence corresponding to the written user-input with a set of stored feature vector sequences, where each feature vector sequence in the set corresponds to a distinct base character. For example, the base character may be identified by determining Levenshtein distances between the normalized feature vector sequence corresponding to the written user-input and a plurality of feature vector sequences in the set. One of the plurality of feature vector sequences may then be selected, if the Levenshtein distance for the selected feature vector sequence is below some predetermined threshold; and the base character may be identified by determining the base character that is associated with the selected feature vector sequence.

Next, in step 382, a functional operator may be applied to the base character to obtain a conjunct character, wherein the functional operator may comprise at least one of a diacritical operator or a conjunct operator. In some embodiments, the conjunct character may be obtained by adding a diacritical mark to the base character at an appropriate location. The diacritical mark may correspond to the diacritical operator and its position may be determined based on the base character and the diacritical operator. Further, in some embodiments, the conjunct character may be obtained by using at least one immediately preceding character and the base character as an index to search a Look-Up Table for a corresponding entry, which may comprise the conjunct character. In some embodiments, the functional operators may be displayed as icons on a virtual keyboard associated with MS 100, and/or invoked by user gestures on touchscreen 172 on MS 100.

In step 384, the conjunct character obtained in step 382 may be displayed. For example, the conjunct character may be displayed on display 172. In some embodiments, the functional operator may comprise a compound functional operator, which may act to apply a plurality of operations, which may be some combination of diacritical and/or conjunct operations to the base character.

In some embodiments, the diacritical and/or functional operators may be repeatedly applied to form complex conjuncts. For example, a triple conjunct character may be formed by using either a compound functional operator or by applying a conjunct operator repeatedly. As one example, the triple conjunct may be formed by combining three consonants. First, a conjunct operator may be applied to a currently entered recognized character and an immediately preceding recognized user-input character to obtain a first conjunct. Next, the conjunct operator may be applied to the first conjunct and another recognized user-input character that immediately precedes the first conjunct to obtain a second triple conjunct. Thus, in the example above, the triple conjunct may be formed by applying the conjunct operator twice. In some embodiments, the triple (or multiple) conjunct may be obtained by using a compound conjunct operator, which, in some embodiments, may be displayed as an icon on display 172. The compound conjunct operator may perform the operations described above when invoked. For example, the compound conjunct may combine the currently entered character with two immediately preceding characters to obtain the triple conjunct.

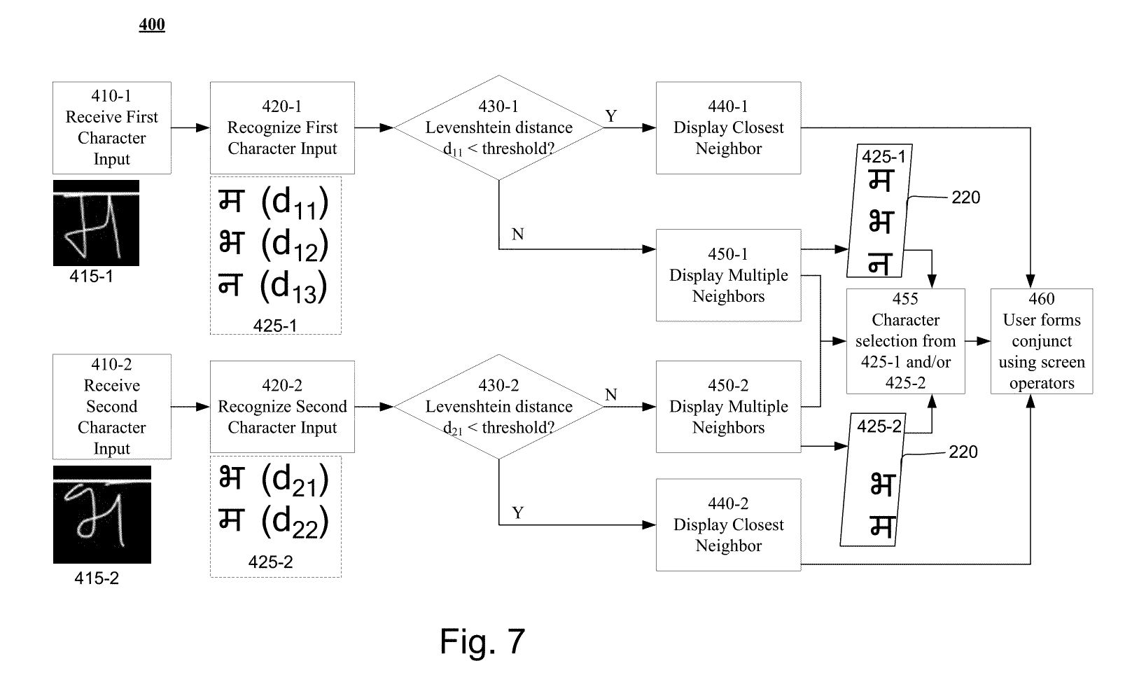

FIG. 7 shows an exemplary process flow 400 illustrating the text input in abugida writing systems with conjuncts in a manner consistent with disclosed embodiments. In some embodiments, method 400 may be implemented on MS 100 using Text Input Module 116.

In steps 410-1 and 410-2 character input may be received. For example, in step 410-1 the character “ [symbol] ” 415-1 may be entered. For example, in one embodiment touch-based user written input may be used to enter character “ [symbol] ” 415-1. Character “ [symbol] ” 415-2 may be entered in step 410-2.

In step 420-1 and 420-2, characters “ [symbol] ” 415-1 and “ [symbol] ” 415-2 may be processed using OCR to recognize the received character input. In some embodiments, the first and second input characters “ [symbol] ” 415-1 and “ [symbol] ” 415-2, respectively, may be recognized using a stroke-based recognition approach. For example, normalized feature vector sequences may be derived for characters “ [symbol] ” 415-1 and “ [symbol] ” 415-2, respectively, based on user input and the normalized feature vector sequences may be used, at least in part, to recognize and/or determine potential matches for the entered characters.

In some embodiments, the sets of potential characters recognized 425-1 and 425-2 may be populated with characters whose feature vector sequences are within some Levenshtein distance of the normalized feature vector sequence associated with the entered/recognized characters. For example, set 425-1 shows the set characters “ [symbol] ”, “ [symbol] ”, and “ [symbol] ” with Levenshtein distances d₁₁, d₁₂, and d₁₃, respectively, as potential matches for input character “ [symbol] ” 415-1. Similarly, set 425-2 shows characters “ [symbol] ” and “ [symbol] ” with Levenshtein distances d₂₁ and d₂₂, respectively, as potential matches for input character “ [symbol] ” 415-2.

In step 430-1, the Levenshtein distance d₁₁ to the nearest neighbor is compared to a threshold. If the Levenshtein distance d₁₁ to the nearest neighbor is below the threshold (“Y” in step 430-1), then, in step 440-1, the closest neighbor “ [symbol] ” is displayed. If the Levenshtein distance d₁₁ to the nearest neighbor is not below the threshold (“N” in step 430-1), then, in step 450-1, the characters in set 425-1 may be displayed.

Similarly, in step 430-2, the Levenshtein distance d₂₁ to the nearest neighbor is compared to a threshold. If the Levenshtein distance d₂₁ to the nearest neighbor is below the threshold (“Y” in step 430-2), then, in step 440-2, the closest neighbor “ [symbol] ” is displayed. If the Levenshtein distance d₂₁ to the nearest neighbor is not below the threshold (“N” in step 430-2), then, in step 450-2, the characters in set 425-2 may be displayed.

For example, if Levenshtein distances d₁₁ and d₂₁ are both above the threshold, then sets 425-1 and 425-2 may be displayed to the user in window 220 on MS 100. In step 455, one of the characters from set 425-1 may be selected as corresponding to input character 410-1 and/or one of the characters from set 425-2 may be selected as corresponding to input character 410-2.

In step 460, for example, the user may use drag and drop operation or pinch and/or may use one or more of the set of functional operator icons 230 displayed in GUI 200 on the characters in window 220 to form a conjunct. In the example shown in FIG. 7, a conjunct may be formed from the characters selected in step 455, and/or from the characters in steps 440-1 and/or 440-2, for example, by using one or more of the set of functional operator icons displayed on screen.

Although the present disclosure is described in relation to the drawings depicting specific embodiments for instructional purposes, the disclosure is not limited thereto. Various adaptations and modifications may be made without departing from the scope. Therefore, the spirit and scope of the appended claims should not be limited to the foregoing description.

What is claimed is:

1. A method on a Mobile Station (MS) for input of text in abugida writing systems, the method comprising:
obtaining a base character, the base character being obtained by performing Optical Character Recognition (OCR) on written user-input on the MS;
applying one or more functional operators to the base character to obtain a conjunct character, the functional operators comprising at least one of a diacritical operator or a conjunct operator; and
displaying the conjunct character.

2. The processor-implemented method of claim 1, wherein applying one or more functional operators to the base character comprises:
displaying the one or more functional operators as icons, each icon corresponding to at least one of the functional operators and
invoking at least one corresponding functional operator upon selection of an icon.

3. The processor-implemented method of claim 1, wherein the functional operators are invoked by one or more user gestures on a touchscreen on the MS.

4. The processor-implemented method of claim 3, wherein the user gestures comprise at least one of:
a drag and drop operation; or
a pinch operation.

5. The processor-implemented method of claim 1, wherein applying the functional operators comprises adding a diacritical mark to the base character at an appropriate location, the diacritical mark corresponding to the diacritical operator.

6. The processor-implemented method of claim 1, wherein displaying the conjunct character comprises using at least one immediately preceding recognized user-input character and the base character as an index to search a Look-Up Table for a corresponding entry, the entry comprising the conjunct character to be displayed.

7. The processor-implemented method of claim 1, wherein performing Optical Character Recognition (OCR) on written user-input further comprises:
obtaining a normalized feature vector sequence corresponding to the written user-input, the normalized feature vector sequence based on a set of contact points associated with the written user input; and
identifying the base character based, at least in part, on a comparison of the normalized feature vector sequence corresponding to the written user-input with a set of stored feature vector sequences, where each stored feature vector sequence in the set corresponds to a distinct base character.

8. The processor-implemented method of claim 7, wherein identifying the base character further comprises:
determining Levenshtein distances between the normalized feature vector sequence corresponding to the written user-input and a plurality of feature vector sequences in the set;
selecting one of the plurality of feature vector sequences, when the Levenshtein distance for the selected feature vector sequence is below a predetermined threshold; and
identifying the base character by determining a base character associated with the selected feature vector sequence.

9. The processor-implemented method of claim 1, wherein the text is Indic text.

10. A Mobile Station (MS) comprising:
a memory to store a plurality of base characters in an abugida writing system,
a touchscreen to receive written user input comprising text for the abugida writing system,
a processor coupled to the memory and the touchscreen, wherein the processor is configured to:
obtain a base character from the plurality of stored base characters, the base character being obtained by performing Optical Character Recognition (OCR) on the written user-input, and
apply one or more functional operators to the base character to obtain a conjunct character, the functional operators comprising at least one of a diacritical operator or a conjunct operator; and
a display coupled to the processor, the display to display the conjunct character.

11. The MS of claim 10, wherein:
the display is configured to display the one or more functional operators as icons, each icon corresponding to at least one of the functional operators; and
the processor is configured to invoke at least one corresponding functional operator upon selection an icon.

12. The MS of claim 10, wherein:
the touchscreen is further configured to receive user gestures; and
the processor invokes the one or more functional operators based, at least in part, on the user gestures.

13. The MS of claim 12, wherein the user gestures comprise at least one of:
a drag and drop operation; or
a pinch operation.

14. The MS of claim 10, wherein:
the processor is further configured to obtain the conjunct character by adding a diacritical mark to the base character at an appropriate location, the diacritical mark corresponding to the diacritical operator.

15. The MS of claim 10, wherein:
the memory further stores a Look-Up Table (LUT) comprising conjunct characters; and
the processor is further configured to obtain the conjunct character by using at least one immediately preceding recognized user-input character and the base character as an index to search the LUT for a corresponding entry, the entry comprising the conjunct character to be displayed.

16. The MS of claim 10, wherein:
the memory further comprises a set of stored feature vector sequences, each stored feature vector sequence in the set corresponding to a distinct character; and
to perform Optical Character Recognition (OCR) on the written user-input, the processor is further configured to:
obtain a normalized feature vector sequence corresponding to the written user-input, the normalized feature vector sequence obtained based on a set of contact points associated with the written user input, and
identify the base character based, at least in part, on a comparison of the normalized feature vector sequence corresponding to the written user-input with a set of stored feature vector sequences, where each feature vector sequence in the set corresponds to a distinct base character.

17. The MS of claim 16, wherein to identify the base character, the processor is further configured to:
determine Levenshtein distances between the normalized feature vector sequence corresponding to the written user-input and a plurality of feature vector sequences in the set;
select one of the plurality of feature vector sequences, if the Levenshtein distance for the selected feature vector sequence is below a predetermined threshold; and
identify the base character by determining a base character associated with the selected feature vector sequence.

18. A Mobile Station (MS) comprising:
storage means to store a plurality of base characters in an abugida writing system,
input means to receive written user input comprising text for the abugida writing systems,
processing means coupled to the storage means and the input means, wherein the processing means further comprises:
means for obtaining a base character, the base character being obtained using Optical Character Recognition (OCR) means to perform OCR on the written user-input, and
means for applying one or more functional operators to the base character to obtain a conjunct character, the functional operators comprising at least one of a diacritical operator or a conjunct operator; and
display means coupled to the processing means, the display means to display the conjunct character.

19. The MS of claim 18, wherein:
the display means is configured to display the functional operators as icons, each icon corresponding to at least one of the functional operators; and
the processing means further comprises:
means for enabling selection of a displayed icon, and
means for invoking at least one corresponding functional operator upon selection of the displayed icon.

20. The MS of claim 18, wherein:
the storage means further comprises a Look-Up Table (LUT) comprising conjunct characters; and
the means for obtaining the conjunct character further comprises searching means, the searching means to use at least one immediately preceding recognized user-input character and the base character as an index to search the LUT for a corresponding entry, the entry comprising the conjunct character to be displayed.

21. The MS of claim 18, wherein:
the storage means further comprises a set of stored feature vector sequences, each stored feature vector sequence in the set corresponding to a distinct character; and
the Optical Character Recognition (OCR) means further comprises:
means for obtaining a normalized feature vector sequence corresponding to the written user-input, the normalized feature vector sequence obtained based on a set of contact points associated with the written user input, and
means for identifying the base character based, at least in part, on a comparison of the normalized feature vector sequence corresponding to the written user-input with a set of stored feature vector sequences, where each feature vector sequence in the set corresponds to a distinct base character.

22. The MS of claim 21, wherein the means for identifying the base character further comprises:
means for determining Levenshtein distances between the normalized feature vector sequence corresponding to the written user-input and a plurality of feature vector sequences in the set;
means for selecting one of the plurality of feature vector sequences, if the Levenshtein distance for the selected feature vector sequence is below a predetermined threshold; and
means for identifying the base character by determining a base character associated with the selected feature vector sequence.

23. A non-transitory computer-readable medium comprising instructions, which when executed by a processor perform steps in method on a Mobile Station (MS) for input of text for abugida writing systems, the steps comprising:
obtaining a base character, the base character being obtained by performing Optical Character Recognition (OCR) on written user-input on the MS;
applying one or more functional operators to the base character to obtain a conjunct character, the functional operators comprising at least one of a diacritical operator or a conjunct operator; and
displaying the conjunct character.

24. The computer-readable medium of claim 23, wherein the functional operators are displayed as icons.

25. The computer-readable medium of claim 23, wherein the functional operator is invoked by user gestures on a touchscreen on the MS.

26. The computer-readable medium of claim 25, wherein the user gestures comprise at least one of:
a drag and drop operation; or
a pinch operation.

27. The computer-readable medium of claim 23, wherein the conjunct character is obtained by adding a diacritical mark to the base character at an appropriate location, the diacritical mark corresponding to the diacritical operator.

28. The computer-readable medium of claim 23, wherein the conjunct character is obtained by using at least one immediately preceding recognized user-input character and the base character as an index to search a Look-Up Table for a corresponding entry, the entry comprising the conjunct character to be displayed.

29. The computer-readable medium of claim 23, wherein performing Optical Character Recognition (OCR) on written user-input further comprises:
obtaining a normalized feature vector sequence corresponding to the written user-input, the normalized feature vector sequence based on a set of contact points associated with the written user input; and
identifying the base character based, at least in part, on a comparison of the normalized feature vector sequence corresponding to the written user-input with a set of stored feature vector sequences, where each feature vector sequence in the set corresponds to a distinct base character.

30. The computer-readable medium of claim 29, wherein identifying the character corresponding to the selected feature vector sequence in the set as a match further comprises:
determining Levenshtein distances between the normalized feature vector sequence corresponding to the written user-input and a plurality of feature vector sequences in the set;
selecting one of the plurality of feature vector sequences, if the Levenshtein distance for the selected feature vector sequence is below a predetermined threshold; and
identifying the base character by determining a base character associated with the selected feature vector sequence.
